(19) United States
(12) Patent Application Publication
(10) Pub. No.: US 2026/0290040 A1
(43) Pub. Date: Sep. 24, 2026

(54) INFORMATION PROCESSING DEVICE, INFORMATION PROCESSING SYSTEM, INFORMATION PROCESSING METHOD, AND NON-TRANSITORY STORAGE MEDIUM

(71) Applicant: HONDA MOTOR CO., LTD., Tokyo (JP)

(72) Inventors: Masahiro Kimura, Wako-shi (JP); Tetsuya Gomi, Tokyo (JP); Yoko Umeyama, Tokyo (JP); Taiki Iwama, Tokyo (JP); Ryuji Iwashita, Wako-shi (JP); Seungho Choi, Wako-shi (JP); Kotaro Masuda, Wako-shi (JP); Yuji Yasui, Wako-shi (JP); Jing Zhao, Tokyo (JP); Adil Gupta, Tokyo (JP); Ryo Takebayashi, Tokyo (JP)

(21) Appl. No.: 19/549,026

(22) Filed: Feb. 25, 2026

(30) Foreign Application Priority Data
Mar. 24, 2025 (JP) 2025-048556

(51) Int. Cl. G06V 20/59; B60Q 9/00; G06V 20/58; G06V 40/16; G07C 5/04

(52) U.S. Cl. CPC G06V 20/597; B60Q 9/00; G06V 20/58; G06V 20/593; G06V 40/161; G07C 5/04

(57) ABSTRACT

An information processing device acquires a facial image including a face of an occupant of a vehicle, determines whether or not there is a fellow passenger of the vehicle based on the facial image, derives driving evaluation information relating to the driving ability of the driver of the vehicle, determines whether or not an abnormality occurs in the driver based on a result of a comparison between the derived driving evaluation information and reference driving evaluation information when it is determined that there is the fellow passenger, and causes a notifier to perform a notification when it is determined that the abnormality occurs in the driver.

### CROSS-REFERENCE TO RELATED APPLICATION

Priority is claimed on Japanese Patent Application No. 2025-048556, filed Mar. 24, 2025, the content of which is incorporated herein by reference.

### BACKGROUND

### Field of the Invention

The present invention relates to an information processing device, an information processing system, an information processing method, and a non-transitory storage medium.

### Description of Related Art

In recent years, efforts to provide access to sustainable transportation systems that take into consideration people in vulnerable positions among traffic participants, such as elderly persons, persons with disabilities, and children, have become more active. To realize this, research and development has been focused on further improving traffic safety or convenience through the development of transportation means for the elderly and persons with disabilities in particular (Japanese Unexamined Patent Application, First Publication Nos. 2020-71528 and 2017-16568).

### SUMMARY

Meanwhile, there is concern that a driver whose cognitive ability has declined for reasons such as aging performs dangerous driving, such as overlooking risks while driving. In order to ensure traffic safety, it is important to monitor the cognitive ability (driving ability) of the driver on a daily basis and to detect and notify a decline in the cognitive ability at an early stage.

The present invention has been made in consideration of such circumstances, and one object of the present invention is to provide an information processing device, an information processing system, an information processing method, and a non-transitory storage medium capable of detecting an abnormality of a driver, and to contribute to the development of sustainable transportation systems.

The information processing device, information processing system, information processing method, and non-transitory storage medium according to the present invention adopt the following configuration.

(1): An information processing device according to an aspect of the present invention includes a storage medium configured to store computer-readable instructions; and one or more processors connected to the storage medium, wherein the one or more processors execute the computer-readable instructions to: acquire a facial image including a face of an occupant of a vehicle; determine whether or not there is a fellow passenger of the vehicle based on the facial image; derive driving evaluation information relating to the driving ability of the driver of the vehicle; determine whether or not an abnormality has occurred in the driver based on a result of a comparison between the derived driving evaluation information and reference driving evaluation information when it is determined that there is the fellow passenger; and cause a notifier to perform a notification when it is determined that the abnormality occurs in the driver.

(2): In the aspect (1), the driving evaluation information is information indicating a level of danger of driving, and the one or more processors execute the computer-readable instructions to determine that the abnormality occurs in the driver when it is determined that there is the fellow passenger and the derived driving evaluation information indicates that the level of danger is higher than the reference driving evaluation information.

(3): In the aspect (1) or (2), the driving evaluation information is information indicating a level of danger of driving, and the one or more processors execute the computer-readable instructions to determine that an abnormality has not occurred in the driver when it is determined that there is no fellow passenger and the derived driving evaluation information indicates that the level of danger is higher than the reference driving evaluation information.

(4): In any one of the aspects (1) to (3), the reference driving evaluation information is information derived based on one driving serving as a reference.

(5): In any one of the aspects (1) to (4), the reference driving evaluation information is information set based on the driving of the driver.

(6): In any one of the aspects (1) to (4), the reference driving evaluation information is information derived based on driving when it is determined that there is no fellow passenger.

(7): In any one of the aspects (1) to (4), the reference driving evaluation information is information derived based on driving when it is determined that there is the fellow passenger.

(8): In any one of the aspects (1) to (4), the reference driving evaluation information is information derived based on a predetermined number of driving operations.

(9): In any one of the aspects (1) to (8), the one or more processors execute the computer-readable instructions to: acquire audio information in a cabin, determine whether or not the driver is receiving a driving instruction based on the audio information and the facial image, the driving instruction being an instruction relating to a driving operation of the vehicle from the fellow passenger, when the fellow passenger is present, and perform no determination as to whether or not an abnormality occurs in the driver when it is determined that the driving instruction is received.

(10): In the aspect (9), the one or more processors execute the computer-readable instructions to: cause a storage unit to store first driving evaluation information, second driving evaluation information and third driving evaluation information, the first driving evaluation information being the driving evaluation information when there is no fellow passenger, the second driving evaluation information being the driving evaluation information when the driving instruction is being received, and the third driving evaluation information being the driving evaluation information when the driving instruction is not being received.

(11): In the aspect (10), the one or more processors execute the computer-readable instructions to: compare the first driving evaluation information, the second driving evaluation information, and the third driving evaluation information, and cause the notifier to output information relating to a result of the comparison.

(12): In any one of the aspects (1) to (10), the one or more processors execute the computer-readable instructions to: acquire a surrounding image of the vehicle, detect a risk object in the surrounding image, determine whether or not the driver has overlooked the risk object based on information relating to a position of the risk object and information relating to the facial image, and derive the driving evaluation information based on a result of determining whether or not the driver overlooks the risk object.

(13): In any one of the aspects (1) to (11), the one or more processors execute the computer-readable instructions to: derive the driving evaluation information based on some or all of information relating to a speed of the vehicle and information relating to a traveling direction of the vehicle.

(14): An information processing system according to an aspect of the present invention includes the information processing device of any one of the aspects (1) to (13); a first terminal device used by the driver, the first terminal device being not the notifier in which the notification is controlled; and a second terminal device used by a user different from the driver, the second terminal device being the notifier in which the notification is controlled, wherein the second terminal device causes the first terminal device to perform a notification based on information input by an operation of the user.

(15): An information processing method according to an aspect of the present invention includes acquiring, by a computer, a facial image including a face of an occupant of a vehicle; determining, by the computer, whether or not there is a fellow passenger of the vehicle based on the facial image; deriving, by the computer, driving evaluation information relating to the driving ability of the driver of the vehicle; determining, by the computer, whether or not an abnormality occurs in the driver based on a result of a comparison between the derived driving evaluation information and reference driving evaluation information when it is determined that there is the fellow passenger; and causing, by the computer, a notifier to perform a notification when it is determined that the abnormality occurs in the driver.

(16): A non-transitory storage medium having a program stored therein according to an aspect of the present invention is stored causes a computer to: acquire a facial image including a face of an occupant of a vehicle, determine whether or not there is a fellow passenger of the vehicle based on the facial image, derive driving evaluation information relating to the driving ability of the driver of the vehicle, determine whether or not an abnormality occurs in the driver based on a result of a comparison between the derived driving evaluation information and reference driving evaluation information when it is determined that there is the fellow passenger, and cause a notifier to perform a notification when it is determined that the abnormality occurs in the driver.

According to (1) to (16), according to the above aspects of the present invention, it is possible to detect a decline in the cognitive ability of the driver.

### BRIEF DESCRIPTION OF THE DRAWINGS

FIG. 1 is a diagram showing an example of a configuration and a usage environment of a driving monitoring device including an information processing device according to a first embodiment.

FIG. 2 is a diagram showing an example of the driving monitoring device according to the first embodiment.

FIG. 3 is a diagram showing an example of an image acquired by the driving monitoring device according to the first embodiment.

FIG. 4 is a diagram showing overlooking alarm processing performed by the driving monitoring device according to the first embodiment.

FIG. 5 is a diagram showing an example of information detected by a detector according to the first embodiment.

FIG. 6 is a diagram showing an example of an alarm performed by an alarm unit according to the first embodiment.

FIG. 7 is a diagram showing abnormality notification processing performed by the driving monitoring device according to the first embodiment.

FIG. 8 is a diagram showing an example of driving evaluation information according to the first embodiment.

FIG. 9 is a diagram showing an example of a comparison between reference driving evaluation information and driving evaluation information according to the first embodiment.

FIG. 10 is a diagram showing another example of the comparison between the reference driving evaluation information and the driving evaluation information according to the first embodiment.

FIG. 11 is a flowchart showing an example of a flow of processing executed by an abnormality determiner according to the first embodiment.

FIG. 12 is a diagram showing an example of a configuration of a driving monitoring device including an information processing device according to a second embodiment.

FIG. 13 is a diagram showing an example of driving ability information according to the second embodiment.

FIG. 14 is a diagram showing an example of a notification performed by a first terminal device (notifier) according to the second embodiment.

FIG. 15 is a diagram showing abnormality notification processing in an information processing system according to the second embodiment.

### DETAILED DESCRIPTION OF EXEMPLARY EMBODIMENTS

Hereinafter, embodiments of an information processing device, an information processing system, an information processing method, and a non-transitory storage medium of the present invention will be described with reference to the drawings. In the following description, a forward direction of the vehicle is defined as a positive X direction, a rearward direction of the vehicle is defined as a negative X direction, a rightward direction based on the positive X direction in a width direction of the vehicle is defined as a positive Y direction, a leftward direction is defined as a negative Y direction, and a direction orthogonal to the X direction and the Y direction, which is a height direction of the vehicle, as a positive Z direction.

### First Embodiment

### Overall Configuration

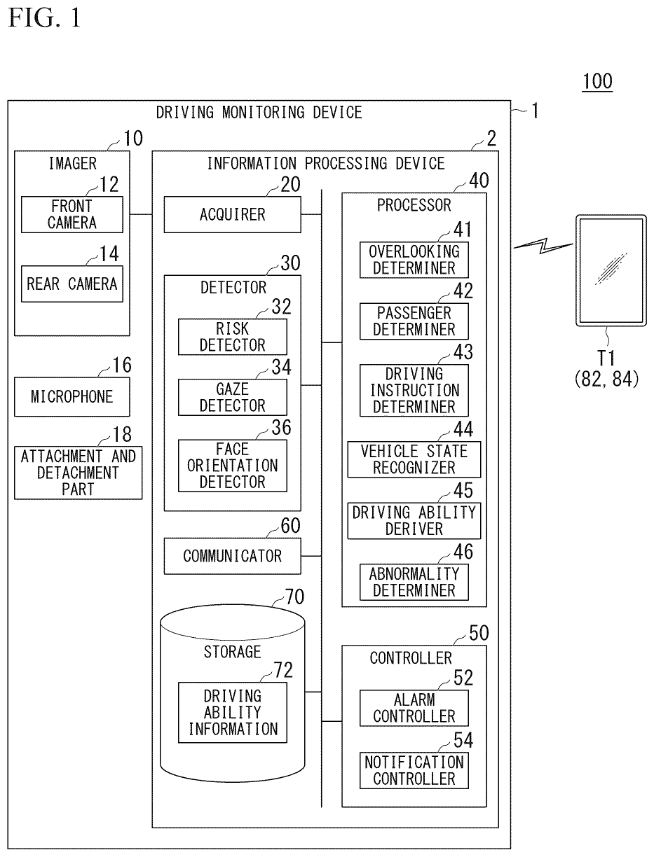

FIG. 1 is a diagram showing an example of a configuration and a usage environment of a driving monitoring device 1 including an information processing device 2 according to a first embodiment. The information processing device 2 is, for example, mounted on the driving monitoring device 1 that is attached later to a vehicle (hereinafter, “vehicle M”) such as a drive recorder. That is, the driving monitoring device 1 (the information processing device 2) is attachable to and detachable from the vehicle M via an attachment and detachment part (hereinafter, “attachment and detachment part 18”). The information processing device 2 is, for example, a device that is not connected to an in-vehicle network of the vehicle M. The in-vehicle network is an in-vehicle network using a communication standard, such as a controller area network (CAN) to which an electronic control unit (ECU) relating to control of the vehicle such as driving, braking, and steering of the vehicle M, various sensors of the vehicle, operators relating to driving, operation buttons, and the like is connected. A network of the vehicle M for a human machine interface (HMI) may be excluded from the in-vehicle network.

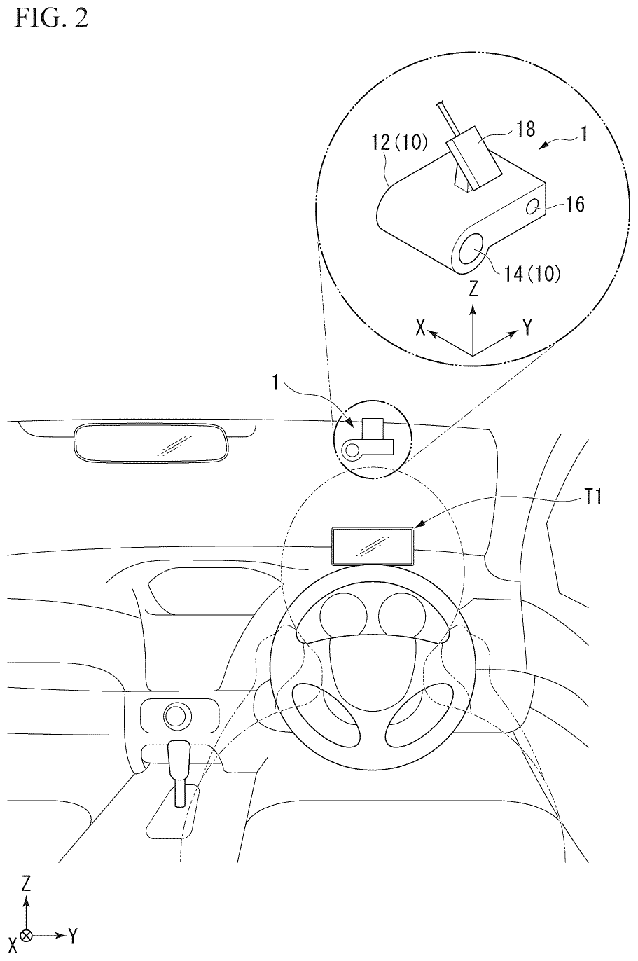

FIG. 2 is a diagram showing an example of the driving monitoring device 1. The driving monitoring device 1 is attached, for example, to a portion located in the vicinity of a front windshield owned by the vehicle M and in the vicinity of a front of a driver's seat. The driving monitoring device 1 causes an image (moving image) captured by an imager 10 to be stored, for example, in a storage 70 (described later). The driving monitoring device 1 may have a configuration including a display device such as a liquid crystal display (LCD) and be capable of causing an image (moving image) stored in the storage 70 to be displayed on the display device.

The driving monitoring device 1 includes, for example, the imager 10, a microphone 16, the attachment and detachment part 18, and the information processing device 2. In the shown example, the imager 10 includes a front camera 12 and a rear camera 14.

Each of the front camera 12 and the rear camera 14 is, for example, a digital camera using a solid-state imaging device such as a charge coupled device (CCD) or complementary metal oxide semiconductor (CMOS). The front camera 12 repeatedly (periodically) images surroundings in front of the vehicle M from a position where the driving monitoring device 1 is attached. The rear camera 14 repeatedly (periodically) images surroundings behind the vehicle M and a cabin of the vehicle M from a position where the driving monitoring device 1 is attached. A horizontal angle of view of each of the front camera 12 and the rear camera 14 is, for example, 180° or more. That is, the driving monitoring device 1 (the imager 10) images a range of 360° around the vehicle M from an attachment position. Each of the front camera 12 and the rear camera 14 may be a fisheye camera including a fisheye lens, for example. Alternatively, each of the front camera 12 and the rear camera 14 may be a wide-angle camera or the like. In the present embodiment, an example in which the front camera 12 and the rear camera 14 are used will be described, but another camera may be used instead of or in addition to these. That is, the imager 10 may be configured so that images (a surrounding image and a facial image to be described later) used in the present embodiment are captured.

The microphone 16 repeatedly (periodically) collects sound in the cabin of the vehicle M. The microphone 16 is installed at an any location of the driving monitoring device 1. The microphone 16 may be installed, for example, beside the rear camera 14. One or a plurality of microphone 16 are attached at any locations of the driving monitoring device 1. The microphone 16 may be configured to be able to collect audio (for example, talking voices) in the cabin. The sound collected by the microphone 16 is referred to as “audio information.”

The attachment and detachment part 18 is, for example, a member for attaching the driving monitoring device 1 to the vehicle M. The attachment and detachment part 18 is any member such as a sucker, a seal, and a supporting member such as a bracket, for example. The attachment and detachment part 18 may include a power supply cable (a wiring or the like) for supplying power to the driving monitoring device 1.

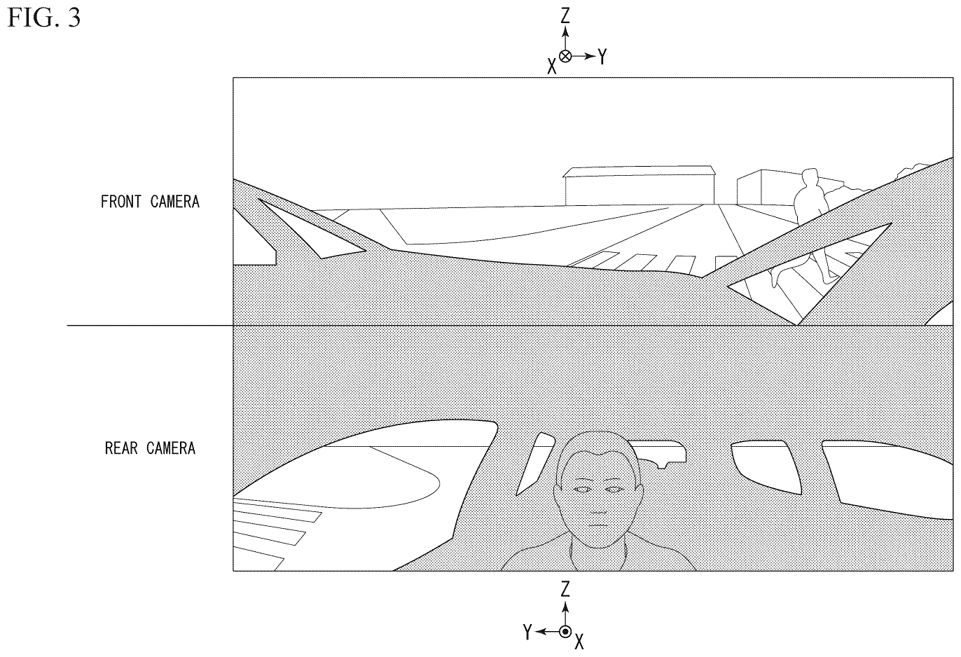

FIG. 3 is a diagram showing an example of an image acquired by the driving monitoring device 1. That is, FIG. 3 is a diagram showing an example of an image captured by the imager 10. The front camera 12 images the front of the vehicle M through the front windshield, a driver side window glass, and a passenger side window glass. The rear camera 14 images, for example, the cabin (occupants including the driver) of the vehicle M, and the rear of the vehicle M through the driver side window glass, the passenger side window glass, and a rear windshield.

In the image captured by the front camera 12 (hereinafter, “front image”), for example, objects present in front of the vehicle M visible through the front windshield and on left and right sides (front) of the vehicle M visible through left and right side window glasses, such as other vehicles, pedestrians, bicycles, fixed objects, road lane markings, appear as subjects.

In the image captured by the rear camera 14 (hereinafter, “rear image”), the cabin of the vehicle M, and objects present behind the vehicle M visible through the rear windshield or on left and right sides (rear) of the vehicle M visible through the left and right side window glasses appear. Therefore, in the rear image captured by the rear camera 14, at least the driver of the vehicle M to which the driving monitoring device 1 is attached appears as a subject.

The front image and the rear image include an image in which a situation around the vehicle M is imaged (hereinafter, a “surrounding image”). The rear image includes an image in which faces of occupants including the driver of the vehicle M are imaged (hereinafter, a “facial image”). The driving monitoring device 1 may be attached at any location as long as the surrounding image and the facial image can be captured by the imager 10.

The information processing device 2 (see FIG. 1) causes alarms and notifications to be output via a first terminal device T1 based on results of referring to the surrounding image and the facial image output from the imager 10. The driving monitoring device 1 and the first terminal device T1 are collectively referred to as an “information processing system 100” in some cases.

The first terminal device T1 is, for example, a portable terminal device used by a driver who drives the vehicle M to which the driving monitoring device 1 is attached, such as a smartphone or a tablet terminal. In the first terminal device T1, for example, an application for receiving alarms and notifications from the information processing device 2 is executed. The application causes an image based on information (for example, alarm information and notification information to be described later) transmitted by the information processing device 2 to be displayed on the display device, or causes sound to be emitted from a speaker. The first terminal device T1 is also referred to as an alarm unit 82 and a notifier 84. The first terminal device T1 is used in a state of being attachable or detachable to or from the vehicle M, for example. For example, a holder for the first terminal device T1 having an attachment and detachment part is provided on one or both of the first terminal device T1 and the vehicle M, and the first terminal device T1 is supported by the holder.

Instead of the first terminal device T1, a navigation device, a display, and a speaker of the vehicle M may be used. That is, the navigation device, the display, and the speaker of the vehicle M may output an alarm and a notification in accordance with an instruction from the information processing device 2. That is, the navigation device of the vehicle M or the display or the speaker of the vehicle M may be the alarm unit 82 or the notifier 84. Instead of the first terminal device T1, the display (the alarm unit 82 and the notifier 84), the speaker (the alarm unit 82 and the notifier 84), or the like may be provided in the driving monitoring device 1.

As shown in FIG. 1, the information processing device 2 includes, for example, an acquirer 20, a detector 30, a processor 40, a controller 50, a communicator 60, and a storage 70. The detector 30 includes a risk detector 32, a gaze detector 34, and a face orientation detector 36. The processor 40 includes an overlooking determiner 41, a fellow passenger determiner 42, the driving instruction determiner 43, a vehicle state recognizer 44, a driving ability deriver 45, and an abnormality determiner 46. The controller 50 includes an alarm controller 52 and a notification controller 54.

The acquirer 20, the detector 30, the processor 40, and the controller 50 each include, for example, a hardware processor such as a central processing unit (CPU), and a storage device that stores a program (software) (a storage device including a non-transitory storage medium), and functions of the respective components are realized by the processor executing the program. Some or all of these components may be realized by, for example, hardware (including circuitry) such as a large scale integration (LSI), an application specific integrated circuit (ASIC), a field-programmable gate array (FPGA), and a graphics processing unit (GPU), or the functions of the respective components may be realized by cooperation between software and hardware. Some or all of these components may have their respective functions realized by a dedicated LSI.

The program (software) may be stored in advance in the storage 70 (a storage device including a non-transitory storage medium) included in the information processing device 2, such as a read only memory (ROM), a random access memory (RAM), and a flash memory, or may be stored in a removable storage medium (a non-transitory storage medium) such as a memory card and be installed in the storage device by the storage medium being mounted on the driving monitoring device 1. The program (software) may be downloaded in advance through near-field communication or wide-area communication from another computer device by an application executed in the first terminal device T1, and be installed in the storage device by being transmitted from the first terminal device T1.

The storage 70 stores, for example, driving ability information 72, programs (for example, the above-described programs), and various other pieces of information. The storage 70 may be realized by various storage devices described above, an electrically erasable programmable read only memory (EEPROM), or the like. The communicator 60 is an interface for performing wireless communication or wired communication with an information processing device (external device) such as the first terminal device T1.

The driving monitoring device 1 (the information processing device 2) performs at least overlooking alarm processing and abnormality notification processing. The overlooking alarm processing is processing for detecting that the driver overlooks the risk object, based on the surrounding image and the facial image and causing the alarm unit 82 to perform an alarm. The abnormality notification processing is processing for detecting an abnormality (decline in cognitive ability) of the driver based on the surrounding image and the facial image and causing the notifier 84 to perform a notification.

The risk object is, for example, an object that the vehicle M should avoid. The risk object is, for example, an object that will interfere with the vehicle M when the vehicle M moves in a current state or an object likely to interfere with the vehicle M. The object likely to interfere with the vehicle M is, for example, an object for which, when a position, a moving direction, and a moving speed of the object, and a position, a moving method, and a moving speed of the vehicle M are taken into consideration, a degree of approach becomes equal to or more than a predetermined degree after a predetermined time. The object may be a traffic participant such as a pedestrian, a bicycle, or a vehicle, or may be an object other than traffic participants, such as an object placed on a road or a fallen object.

### Overlooking Alarm Processing

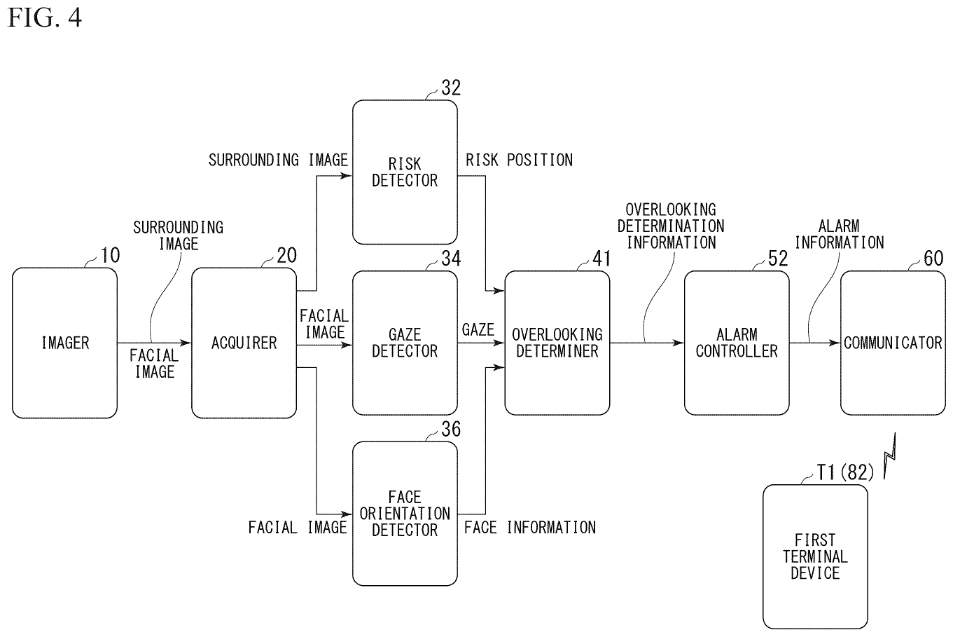

FIG. 4 is a diagram showing the overlooking alarm processing performed by the driving monitoring device 1 (the information processing device 2).

The acquirer 20 acquires the front image and the rear image from the imager 10. Accordingly, the acquirer 20 acquires the surrounding image and the facial image in association with each other. Since the imager 10 captures the surrounding image and the facial image repeatedly (periodically), the acquirer 20 repeatedly (periodically) acquires the surrounding image and the facial image. The acquirer 20 may acquire the surrounding image and the facial image in association with times (imaging times) at which the surrounding image and the facial image have been captured.

The risk detector 32 detects a risk object in the surrounding image. “Detecting a risk object” means, for example, detecting that the risk object is present and detecting a position of the risk object (hereinafter, referred to as a risk position) with respect to the vehicle M (the driving monitoring device 1). For example, reference information (not shown) showing a relationship between the risk position in the surrounding image and a position relative to the vehicle M may be stored in the storage 70 in advance. The risk detector 32 may detect the position of the risk object with respect to the vehicle M based on this reference information.

The risk detector 32 detects a relative position of the risk object with respect to the vehicle M to also detect a presence direction (approach direction) of the risk object with respect to the vehicle M. The “presence direction of the risk object” is, for example, a presence direction of the risk object approaching the vehicle M (the driving monitoring device 1) with respect to the vehicle M (the driving monitoring device 1). Hereinafter, the “presence direction of the risk object” is sometimes referred to as a “risk presence direction.”

The gaze detector 34 detects a gaze of the driver in the facial image. Specifically, the gaze detector 34 detects the gaze of the driver by analyzing the facial image using a predetermined image analysis technique. “Detecting a gaze” means, for example, detecting a position of an eyeball of the driver and an orientation of a gaze (an orientation of the eyeball).

The face orientation detector 36 detects at least the orientation of the face of the driver in the facial image. Specifically, the face orientation detector 36 analyzes the facial image using a predetermined image analysis scheme to detect the orientation of the face of the driver. The face orientation detector 36 may detect a position of the face of the driver in addition to the orientation of the face of the driver. Hereinafter, information that is a combination of the “the orientation of the face” and the “position of the face” is sometimes referred to as “face information.” The face orientation detector 36 detects the face information in the facial image.

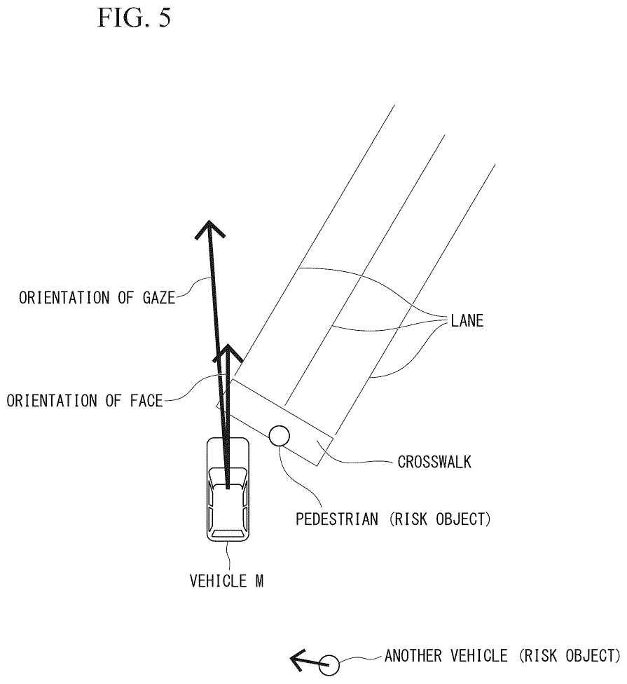

The detector 30 may be configured to be able to detect lanes, crosswalks, and the like, in addition to the above-described risk object, gaze, and face information. FIG. 5 is a diagram showing an example of information detected by the detector 30. In the example of FIG. 5, pedestrians, other vehicles, lanes, and crosswalks detected by the detector 30 are shown based on the vehicle M, the orientation of the gaze, and the orientation of the face. The pedestrians and other vehicles are examples of traffic participants (objects) that can become risk objects. Detected information may be information in which traffic participants (objects) that can become the risk object detected by the detector 30 are shown based on the vehicle M, the orientation of the vehicle M, and a traveling direction of the vehicle M instead of the vehicle M, the orientation of the gaze, and the orientation of the face.

The overlooking determiner 41 (see FIG. 4) determines whether or not the driver overlooks the risk object based on the risk position and/or the risk presence direction, the gaze, and the face information. Each of the “risk position” and the “risk presence direction” is an example of “information relating to the position of the risk object.” The gaze and the face information are examples of “information relating to the facial image.”

For example, reference information (not shown) showing a relationship between an orientation of an eyeball (gaze) and/or the orientation of the face of the driver in the facial image and a relative direction with respect to the traveling direction of the vehicle M may be stored in the storage 70 in advance. The overlooking determiner 41 may determine whether or not the orientation of the gaze and/or the orientation of the face matches the risk presence direction with reference to this reference information. In a case in which the orientation of the gaze and/or the orientation of the face matches the risk presence direction, the overlooking determiner 41 may determine that the driver visually recognizes the risk object. “The case in which the orientation of the gaze and/or the orientation of the face matches the risk presence direction” may be a case in which the risk position is present on a straight line along the orientation of the gaze and/or the orientation of the face, for example. Alternatively, “the case in which the orientation of the gaze and/or the orientation of the face matches the risk presence direction” may be a case in which the risk position is present within a conical region having a central axis along the orientation of the gaze and/or the orientation of the face with a viewpoint (eyeball) and/or a position of the face as a vertex and having side surfaces widening toward the front. In a case in which the orientation of the gaze and/or the orientation of the face does not match the position of the risk object, the overlooking determiner 41 may determine that the driver does not visually recognize the risk object.

The overlooking determiner 41 may determine that the driver overlooks the risk object when a state in which the driver does not visually recognize the risk object continues for a predetermined time or more. The overlooking determiner 41 may determine that the driver does not overlook the risk object when the driver visually recognizes the risk object or when a state in which the driver does not visually recognize the risk object is resolved before elapse of the predetermined time. However, a scheme for the overlooking determiner 41 determining overlooking is not limited to the above and can be appropriately changed.

The overlooking determiner 41 generates overlooking determination information based on the determination result. The overlooking determination information includes, for example, presence or absence of the overlooking described above and the risk presence direction.

The alarm controller 52 causes the first terminal device T1 (the alarm unit 82) to output an alarm based on the overlooking determination information. For example, the alarm controller 52 transmits the alarm information to the first terminal device T1 via the communicator 60. The alarm information includes, for example, information indicating necessity of an alarm and the risk presence direction. The alarm controller 52 generates alarm information including information indicating “an alarm is necessary” when information indicating “there is overlooking” is included in the overlooking determination information. The alarm controller 52 generates alarm information including information indicating “an alarm is not necessary” when information indicating “there is no overlooking” is included in the overlooking determination information. The first terminal device T1 outputs an alarm based on the alarm information.

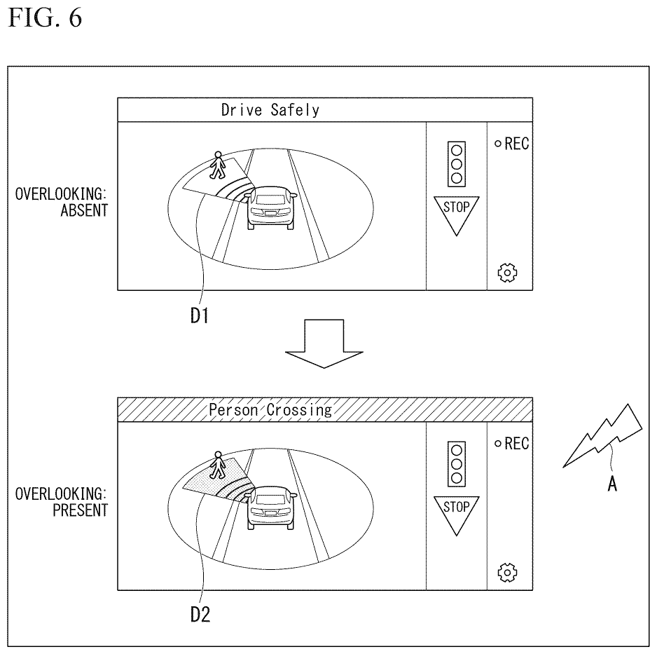

FIG. 6 is a diagram showing an example of an alarm performed by the first terminal device T1 (the alarm unit 82). In the example of FIG. 6, the first terminal device T1 displays content in which the risk presence directions (D1 and D2 in the figure) are recognizable. The first terminal device T1 performs an alarm by making modes of display of the risk presence direction different between a case in which there is overlooking of the risk object (that is, a case in which information indicating “an alarm is necessary” is included in the alarm information) and a case in which there is no overlooking of the risk object (that is, a case in which information indicating “an alarm is not necessary” is included in the alarm information). Specifically, when there is overlooking of the risk object, the risk presence direction is displayed in a more emphasized mode as compared with the case in which there is no overlooking. The emphasized mode is, for example, a mode in which the driver can more easily visually recognize the risk presence direction, such as emphasis using color or emphasis using blinking or lighting an icon. The first terminal device T1 may perform an alarm by emitting sound from the speaker or by emitting light from a light in addition to or instead of the above (A in the figure). A concrete alarm method can be appropriately changed as long as the alarm is recognizable by the driver.

The alarm from the first terminal device T1 (the alarm unit 82) may be performed at a timing when the driver is driving the vehicle M (that is, in real time), for example. Examples of the “timing when the driver is driving the vehicle M” include timings such as during traveling of the vehicle M and during temporary stop of the vehicle M. For example, transmission of the alarm information in the alarm controller 52 may be performed at the above timing. Alternatively, the transmission of the alarm information in the alarm controller 52 may be performed at any timing, and the first terminal device T1 (the alarm unit 82) may control an alarm timing so that an alarm is performed at the above timing.

### Abnormality Notification Processing

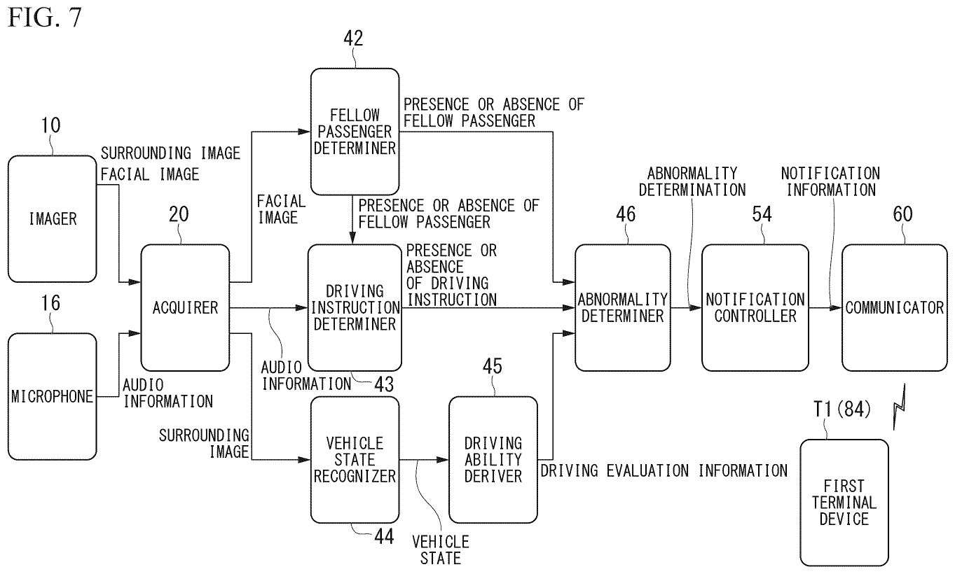

FIG. 7 is a diagram showing abnormality notification processing performed by the driving monitoring device 1 (the information processing device 2).

The acquirer 20 further acquires the audio information from the microphone 16, in addition to the front image and the rear image. Accordingly, the acquirer 20 acquires the surrounding image, the facial image, and the audio information in association with each other. Since the imager 10 captures the surrounding image and the facial image repeatedly (periodically) and the microphone 16 similarly acquires the audio information repeatedly (periodically), the acquirer 20 repeatedly (periodically) acquires the surrounding image, the facial image, and the audio information. The acquirer 20 may acquire the surrounding image, the facial image, and the audio information in association with time (imaging time) at which the surrounding image, the facial image, and the audio information have been captured.

The fellow passenger determiner 42 determines whether or not a fellow passenger of the vehicle M is present based on the facial image. When the facial image includes the fellow passenger of the vehicle M, the fellow passenger determiner 42 determines that there is the fellow passenger. When the facial image does not include the fellow passenger of the vehicle M, the fellow passenger determiner 42 determines that there is no fellow passenger. The fellow passenger of the vehicle M indicates an occupant other than the driver of the vehicle M.

The driving instruction determiner 43 determines whether or not the driver is receiving the driving instruction from the fellow passenger based on the audio information and the facial image. Specifically, when the fellow passenger determiner 42 determines that there is the fellow passenger, the driving instruction determiner 43 determines whether or not the driver is receiving a driving instruction from the fellow passenger based on the audio information and the facial image. The driving instruction is an instruction relating to a driving operation of the vehicle M. The driving instruction may be, for example, an instruction indicating that a risk object is present, or may be an instruction to specify the speed or the traveling direction of the vehicle M. The driving instruction may be an instruction such that, by receiving the instruction, the driver is expected to execute a steering operation or speed adjustment of the vehicle M.

The driving instruction determiner 43 may analyze the facial image using a predetermined image analysis scheme to detect a direction of the face of the fellow passenger. The driving instruction determiner 43 may analyze the audio information using a predetermined audio analysis technique to detect content of voice uttered by the fellow passenger. The driving instruction determiner 43 may determine that the driving instruction is being received when the face of the fellow passenger the driver and content relating to the driving instruction is included in the content of the voice uttered by the fellow passenger. The driving instruction determiner 43 may determine that the driving instruction is not being received when the face of the fellow passenger does not face the direction of the driver or content relating to the driving instruction is not included in the content of the voice uttered by the fellow passenger.

The vehicle state recognizer 44 recognizes a vehicle state which is a state of the vehicle M based on the surrounding image. The vehicle state is, for example, a change amount of the speed or the traveling direction of the vehicle M. For example, reference information (not shown) showing a relationship between a change amount of a position of an object among a plurality of surrounding images arranged in chronological order and the speed of the vehicle M, and reference information (not shown) showing a relationship between the change amount of the position of the object among the plurality of surrounding images arranged in chronological order and the traveling direction (a steering state) of the vehicle M may be stored in the storage 70 in advance. The vehicle state recognizer 44 may recognize the state of the vehicle M based on the reference information. By recognizing the vehicle state, the vehicle state recognizer 44 can recognize that the driver has turned a steering wheel abruptly or has performed rapid acceleration, a sudden stop, and the like.

The information processing device 2 may recognize the change amount of the speed or the traveling direction (the vehicle state) of the vehicle M based on information detected by an acceleration sensor, speed information and steering information of the vehicle M, or the like in place of or in addition to the vehicle state recognizer 44. For example, the information processing device 2 may recognize the vehicle state by acquiring acceleration information detected by the acceleration sensor included in the driving monitoring device 1 using the acquirer 20 and analyzing the acquired acceleration information using the processor 40. For example, the information processing device 2 may acquire, via the communicator 60, information relating to the speed of the vehicle M or information relating to steering from the vehicle M, and recognize the vehicle state based on the acquired information.

The vehicle state recognized by the information processing device 2 via the communicator 60 may include, for example, performing right or left turn without operating a turn signal, overspeed relative to a speed limit, the presence of speed reduction, and a high frequency of horn use. When these vehicle states are recognized by the abnormality determiner 46 to be described later, a level of danger is evaluated as high.

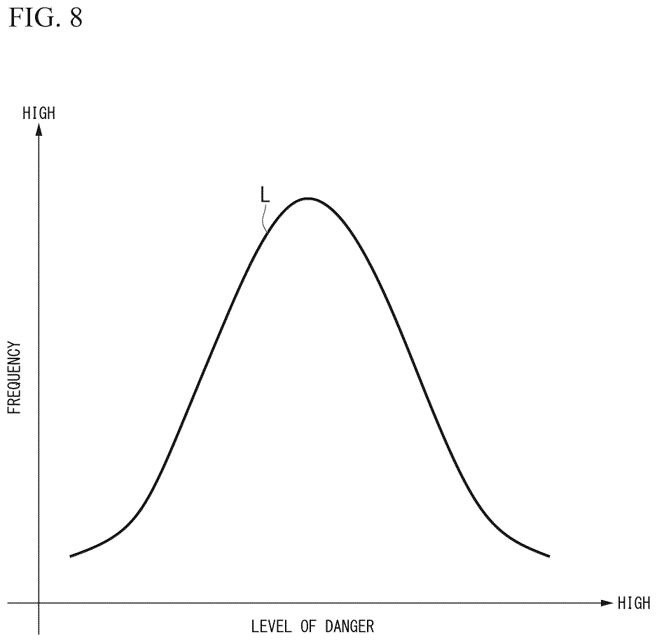

The driving ability deriver 45 derives driving evaluation information which is information relating to the driving ability of the driver. FIG. 8 is a diagram showing an example of the driving evaluation information. In a graph in FIG. 8, a vertical axis indicates frequency and a horizontal axis indicates a level of danger. A vertical axis has an upward direction as a positive direction, and the frequency becomes higher as the upward direction is approached. A horizontal axis has a right direction as a positive direction, and the level of danger becomes higher as the right direction is approached. FIG. 8 includes driving evaluation information L. The driving evaluation information L is information indicating a correlation between a level of danger of driving and a frequency in driving in a predetermined period. The driving ability is evaluated such that, for example, the larger the number of times the overlooking determiner 41 determines that the driver overlooks the risk object or the larger the change amount of the speed or the traveling direction of the vehicle M recognized by the vehicle state recognizer 44, the higher the level of danger. The driving ability is evaluated such that, the smaller the number of times the overlooking determiner 41 determines that the driver does not overlook the risk object or the smaller the change amount of the speed or the traveling direction of the vehicle M recognized by the vehicle state recognizer 44, the lower the level of danger. The level of danger may be represented by a numerical value or may be represented by levels such as high, medium, and low.

When driving of the vehicle M is being performed, the driving ability deriver 45 acquires danger level information indicating a level of danger of driving periodically based on a determination result from the overlooking determiner 41, the vehicle state, and the like. The driving ability deriver 45 calculates the frequency by counting the number of times each level of danger appears based on a plurality of pieces of danger level information acquired in a predetermined period, and derives the driving evaluation information L. That is, the frequency indicates, for example, a number of times driving corresponding to each level of danger has been performed. The predetermined period is a period set in advance. The predetermined period may be, for example, one driving operation or may be a plurality of (a predetermined number of) driving operations. One driving may indicate, for example, driving during a period from engine start to stop.

The abnormality determiner 46 determines whether or not an abnormality occurs in the driver based on a comparison result between the reference driving evaluation information and the driving evaluation information. The reference driving evaluation information is set, for example, based on driving performed by the driver of the vehicle M in the past. In this case, the reference driving evaluation information may be set based on the driving evaluation information derived at the time of one or a plurality of driving operations in the past serving as a reference. The reference driving evaluation information may be set based on an average driving ability of a healthy person.

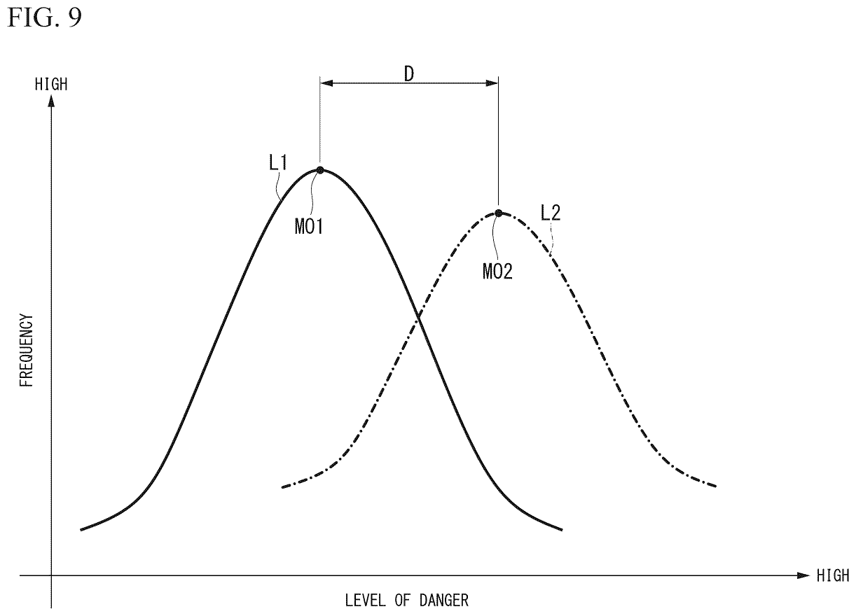

FIG. 9 is a diagram showing an example of a comparison between the reference driving evaluation information and the driving evaluation information. In a graph in FIG. 9, a vertical axis indicates the frequency and a horizontal axis indicates the level of danger, similarly to FIG. 8. FIG. 9 includes a reference driving evaluation information L1 and a driving evaluation information L2. The abnormality determiner 46 calculates a mode difference D which is an absolute value of a difference between a mode MO1 which is a level of danger corresponding to a mode of the reference driving evaluation information L1 and a mode MO2 which is a level of danger corresponding to a mode of the driving evaluation information L2. The abnormality determiner 46 may determine that an abnormality occurs in the driver, for example, when the mode difference D is equal to or more than a preset set value (threshold). The abnormality determiner 46 may determine that the abnormality does not occur in the driver, for example, when the mode difference D is less than the set value. The set value may be set in advance or may be set in accordance with, for example, a state of a traveling road of the vehicle M or surroundings detected by the detector 30. For example, when the vehicle M is traveling on a traveling road on which sharp curves continue or when surroundings are in a state of dense fog, the set value may be set as a great value. This is because, in such a case, it is predicted that the change amount of the traveling direction of the vehicle M becomes large and the number of times of overlooking of the risk object becomes large.

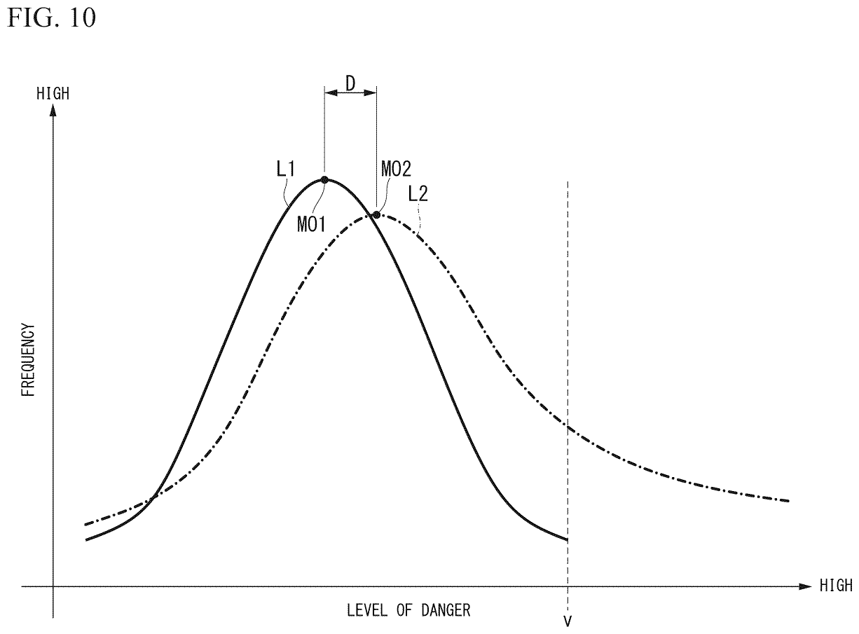

FIG. 10 is a diagram showing another example of a comparison between the reference driving evaluation information and the driving evaluation information. Differences from FIG. 9 will be mainly described. In FIG. 10, the mode difference D is less than the set value. From the driving evaluation information L2, it can be seen that driving with a high level of danger is performed although the frequency is low at the time of driving that is a derivation source of the driving evaluation information L2. The abnormality determiner 46 may determine that an abnormality occurs in the driver when a level of danger equal to or more than a predetermined level of danger V is included in the driving evaluation information L2. The abnormality determiner 46 may determine that an abnormality does not occur in the driver when a level of danger equal to or more than the predetermined level of danger V is not included in the driving evaluation information L2. The predetermined level of danger V is a value set based on the reference driving evaluation information L1. The predetermined level of danger V may be, for example, the greatest level-of-danger value included in the reference driving evaluation information L1. The predetermined level of danger V may be, for example, a level-of-danger value that is greater than a mode MO1 and may be a level-of-danger value at a frequency equal to or higher than a predetermined frequency in the reference driving evaluation information L1.

However, a scheme for determining whether or not an abnormality occurs in the driver in the abnormality determiner 46 is not limited to the above and can be appropriately changed.

The abnormality determiner 46 generates abnormality determination information based on the determination result. The abnormality determination information includes, for example, presence or absence of the abnormality occurring in the driver described above and the driving evaluation information.

Thus, when the derived driving evaluation information indicates that the level of danger is higher than the reference driving evaluation information, it is possible to detect a decline in the driving ability of the driver by the abnormality determiner 46 determining that the abnormality occurs in the driver.

The abnormality determiner 46 may change the set value depending on the presence or absence of a fellow passenger. The abnormality determiner 46 may make the set value small when it is determined that there is the fellow passenger. This is because the level of danger of driving in a case in which the fellow passenger is present tends to be lower as compared with a case in which there is no fellow passenger, and therefore, the cognitive ability of the driver is highly likely to decline even when the mode difference D is small. The abnormality determiner 46 may make the set value great when it is determined that there is no fellow passenger. This is because the level of danger of driving in a case in which there is no fellow passenger tends to be higher as compared with a case in which the fellow passenger is present, and therefore, the cognitive ability of the driver is highly likely not to decline even when the mode difference D is large.

Thus, by setting the set value depending on the presence or absence of the fellow passenger, even when the derived driving evaluation information indicates a higher level of danger than the reference driving evaluation information, the abnormality determiner 46 determines that an abnormality does not occur in the driver when there is no fellow passenger, thereby preventing false detection for a decline in the cognitive ability of the driver.

The abnormality determiner 46 may change the reference driving evaluation information serving as a comparison target depending on the presence or absence of the fellow passenger. The reference driving evaluation information with which comparison is performed when the fellow passenger is present is referred to as first reference driving evaluation information, and the reference driving evaluation information with which comparison is performed when there is no fellow passenger is referred to as second reference driving evaluation information. The first reference driving evaluation information is reference driving evaluation information set based on driving when the fellow passenger is present, and the second reference driving evaluation information is reference driving evaluation information set based on driving when there is no fellow passenger. The first reference driving evaluation information and the second reference driving evaluation information may be set based on past driving of the driver similarly to the reference driving evaluation information described above, or may be set based on the average driving ability of the healthy person.

Thus, when the first reference evaluation information and the second reference evaluation information are set, the abnormality determiner 46 determines whether or not an abnormality occurs in the driver based on a comparison result between the first reference driving evaluation information and the driving evaluation information when the fellow passenger determiner 42 determines that there is the fellow passenger. The abnormality determiner 46 determines whether or not an abnormality occurs in the driver based on a comparison result between the second reference driving evaluation information and the driving evaluation information when the fellow passenger determiner 42 determines that there is no fellow passenger.

When the driving instruction determiner 43 determines that the driving instruction is received, the abnormality determiner 46 may not perform the determination as to whether or not an abnormality occurs in the driver described above. When it is determined that the driving instruction is received, the driving evaluation information derived by the driving ability deriver 45 may have a possibility that the level of danger is lowered due to the driver receiving the driving instruction from the fellow passenger. That is, when the driver receives the driving instruction from the fellow passenger, a possibility that overlooking of the risk object or sudden changes in the speed or the traveling direction of the vehicle M are avoided is high. Thus, by not performing the determination as to whether or not the abnormality occurs in the driver in a situation in which a change in the driving ability is highly likely to be observed, it is possible to appropriately detect the decline in the cognitive ability of the driver.

The notification controller 54 causes the first terminal device T1 (the notifier 84) to output a notification based on the abnormality determination information. For example, the notification controller 54 transmits notification information to the first terminal device T1 via the communicator 60. For example, when information indicating that there is an abnormality in the driver is included in the abnormality determination information (that is, when the abnormality determiner 46 determines that an abnormality occurs in the driver), the notification controller 54 may transmit first notification information to the first terminal device T1. The first notification information includes, for example, information indicating the driving evaluation information. When information indicating that there is no abnormality in the driver is included in the abnormality determination information (that is, when the abnormality determiner 46 determines that an abnormality does not occur in the driver), the notification controller 54 may not transmit the first notification information to the first terminal device T1.

The first terminal device T1 (the notifier 84) outputs a notification based on the first notification information. The notification may be performed by causing a display device included in the first terminal device T1 (the notifier 84) to display a character string or an image based on the first notification information, for example.

The notification in the first terminal device T1 (the notifier 84) may include content recommending a medical consultation at a medical institution (for example, a primary care physician of the driver). In this case, the first terminal device T1 (the notifier 84) may cause the driver to input information indicating whether or not the driver accepts the medical consultation at the medical institution. Specifically, the first terminal device T1 (the notifier 84) may display a virtual button or the like indicating acceptance of the medical consultation on the display device. Such a button or the like functions as an acceptance information acquirer to acquirer acceptance information. The acceptance information is information indicating an intention of the driver to accept the medical consultation at the medical institution. When the driver operates the first terminal device T1 (the notifier 84) and the acceptance information acquirer acquires acceptance-consultation information, the first terminal device T1 (the notifier 84) may cause a notification indicating that the driver has accepted the medical consultation to be made to a predetermined information processing terminal. The predetermined information processing terminal may be, for example, a terminal (for example, a second terminal device T2 to be described later) used by personnel belonging to a medical institution. Specifically, the predetermined information processing terminal may be a terminal used by personnel (for example, a doctor and a nurse) belonging to a medical institution, for example.

However, a mode of the notification in the first terminal device T1 (the notifier 84) is not particularly limited and can be appropriately changed as long as the mode can be recognized by the driver.

The notification from the first terminal device T1 (the notifier 84) may be performed at a timing other than when the driver is driving the vehicle M, for example. Examples of the “timing other than when the driver is driving the vehicle M” include timings such as during a stop of the vehicle M, after the driver ends the driving of the vehicle M, and when the driver has left the vehicle M and is at home. For example, transmission of the first notification information in the notification controller 54 may be performed at the above timing. Alternatively, the transmission of the first notification information in the notification controller 54 may be performed at any timing, and the first terminal device T1 (the notifier 84) may control a notification timing so that the notification is performed at the above timing.

### Processing Flow

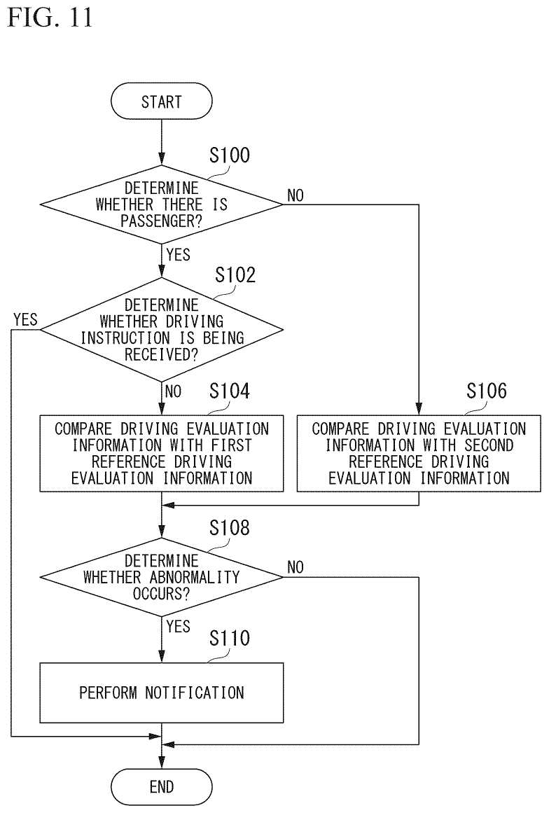

FIG. 11 is a flowchart showing an example of a flow of processing executed by the information processing device 2. The processing in the flowchart shown in FIG. 11 may be started repeatedly at a predetermined timing such as after driving end or a predetermined cycle, for example, or may be started according to an instruction of the driver or the like.

First, the fellow passenger determiner 42 determines whether or not a fellow passenger is present (step S100). When it is determined that there is the fellow passenger (step S100; YES), the driving instruction determiner 43 determines whether or not the driver is receiving the driving instruction (step S102). When it is determined that the driver is not receiving the driving instruction (step S102; NO), the abnormality determiner 46 compares the driving evaluation information with the first reference driving evaluation information (step S104). Next, the abnormality determiner 46 determines whether or not an abnormality occurs in the driver based on a comparison result between the driving evaluation information and the first reference driving evaluation information (step S108). In this case, the abnormality determiner 46 may generate the abnormality determination information. When it is determined that an abnormality occurs in the driver (step S108; YES), the notification controller 54 causes a notification to be output to the first terminal device T1 (the notifier 84) based on the abnormality determination information (step S110). Thereafter, the information processing device 2 ends the processing in the flowchart shown in FIG. 11.

On the other hand, when it is determined that there is no fellow passenger (step S100; NO), the abnormality determiner 46 compares the driving evaluation information with the second reference driving evaluation information (step S106). Next, the abnormality determiner 46 determines whether or not an abnormality occurs in the driver based on a comparison result between the driving evaluation information and the second reference driving evaluation information (step S108). In this case, the abnormality determiner 46 may generate the abnormality determination information. When it is determined that an abnormality occurs in the driver (step S108; YES), the notification controller 54 causes a notification to be output to the first terminal device T1 (the notifier 84) based on the abnormality determination information (step S110). Thereafter, the information processing device 2 ends the processing in the flowchart shown in FIG. 11.

When it is determined that the driver is receiving the driving instruction (step S102; YES), or when it is determined that an abnormality does not occur in the driver (step S108; NO), the information processing device 2 ends the processing in the flowchart shown in FIG. 11.

According to the first embodiment described above, the information processing device 2 includes the acquirer 20 that acquires a facial image including a face of an occupant of a vehicle, the fellow passenger determiner 42 that determines whether or not there is a fellow passenger of the vehicle based on the facial image, the driving ability deriver 45 that derives the driving evaluation information which is information relating to the driving ability of the driver of the vehicle, the abnormality determiner 46 that determines whether or not an abnormality occurs in the driver based on a result of a comparison between the derived driving evaluation information and reference driving evaluation information when it is determined that there is the fellow passenger, and the notification controller 54 that causes the notifier to perform a notification when it is determined that an abnormality occurs in the driver. Accordingly, it is possible to detect the decline in the cognitive ability of the driver. For example, a driver who is an elderly person is notified of information on the decline in the cognitive ability at an early stage, thereby preventing an accident beforehand. It is possible to extend a driving life, provide a safe and secure driving experience, and lead to creating a richer life by extending a healthy life.

### Second Embodiment

Next, a second embodiment will be described, but a basic configuration is the same as that of the first embodiment. Therefore, the same configurations are denoted by the same reference numerals, description thereof is omitted, and only differences will be described.

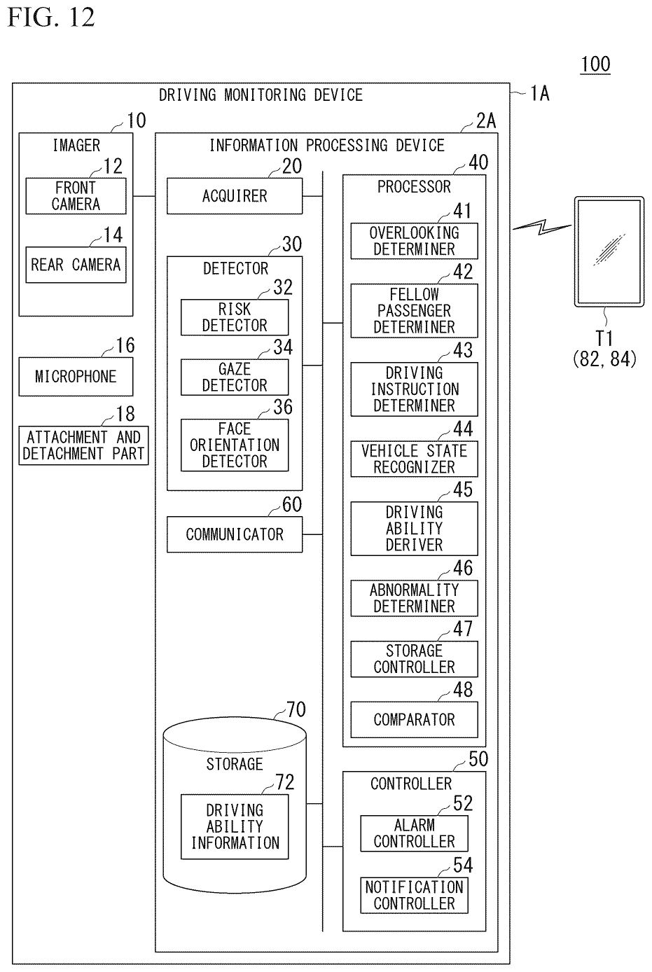

FIG. 12 is a diagram showing an example of a configuration of a driving monitoring device 1A including an information processing device 2A according to the second embodiment. The information processing device 2A according to the second embodiment differs from the information processing device 2 according to the first embodiment in that the processor 40 further includes a storage controller 47 and a comparator 48 (see also FIG. 1).

The storage controller 47 causes the storage 70 to store a derivation date and time, the driving evaluation information, the presence or absence of the fellow passenger, and presence or absence of the driving instruction in association with each other. The derivation date and time is a date and time when the driving evaluation information is derived. The derivation date and time may be acquired from date and time information included in the surrounding image, the facial image, or the audio information, for example. The above processing by the storage controller 47 is performed each time the driving evaluation information is derived by the driving ability deriver 45, for example. Hereinafter, the information stored in the storage 70 in this way is referred to as the driving ability information 72.

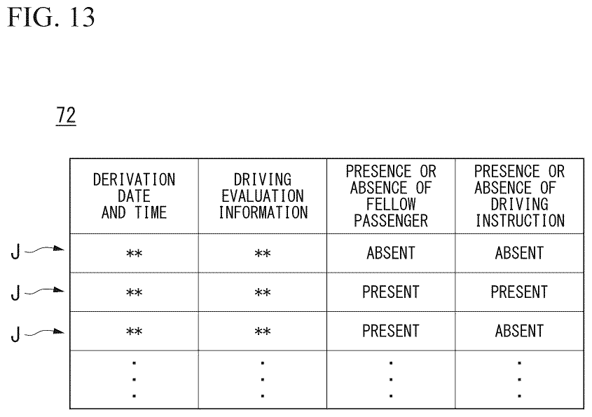

FIG. 13 is a diagram showing an example of the driving ability information 72. By the storage processing being repeated by the storage controller 47, a plurality of sets of information including the derivation date and time, the driving evaluation information, the presence or absence of the fellow passenger, and presence or absence of the driving instruction (hereinafter, referred to as a “derivation information set J”) are accumulated in the driving ability information 72. That is, the storage controller 47 generates the derivation information set J each time the driving evaluation information is derived by the driving ability deriver 45. The storage controller 47 updates the driving ability information 72 by adding the generated derivation information set J to the driving ability information 72.

Returning to FIG. 12, the comparator 48 generates comparison information based on the driving ability information 72. Specifically, the comparator 48 compares first driving evaluation information, second driving evaluation information, and third driving evaluation information. The comparison information is the information of a result of the cooperation. The first driving evaluation information is driving evaluation information when there is no fellow passenger. The second driving evaluation information is driving evaluation information when the driving instruction is being received. The third driving evaluation information is driving evaluation information when the driving instruction is not being received. The comparison information may be information obtained by comparing a mode of the level of danger based on the first driving evaluation information, a mode of the level of danger based on the second driving evaluation information, and a mode of the level of danger based on the third driving evaluation information, for example.

The comparator 48 may perform the above processing (comparison processing) each time the driving evaluation information is derived by the driving ability deriver 45, or may perform the above processing based on the instruction from the driver and the like. The comparator 48 may perform the above processing based on all the derivation information sets J included in the driving ability information 72, or may perform the above processing based on some of the derivation information sets J included in the driving ability information 72. The some of the derivation information sets J may be derivation information sets J whose derivation date and time is included in a period specified by the driver or the like, for example.

In this case, the notification controller 54 causes the first terminal device T1 (the notifier 84) to output a notification based on the comparison information. For example, the notification controller 54 may transmit second notification information to the first terminal device T1 each time the comparison processing is performed by the comparator 48. The second notification information may include, for example, information relating to the first driving evaluation information, the second driving evaluation information, and the third driving evaluation information.

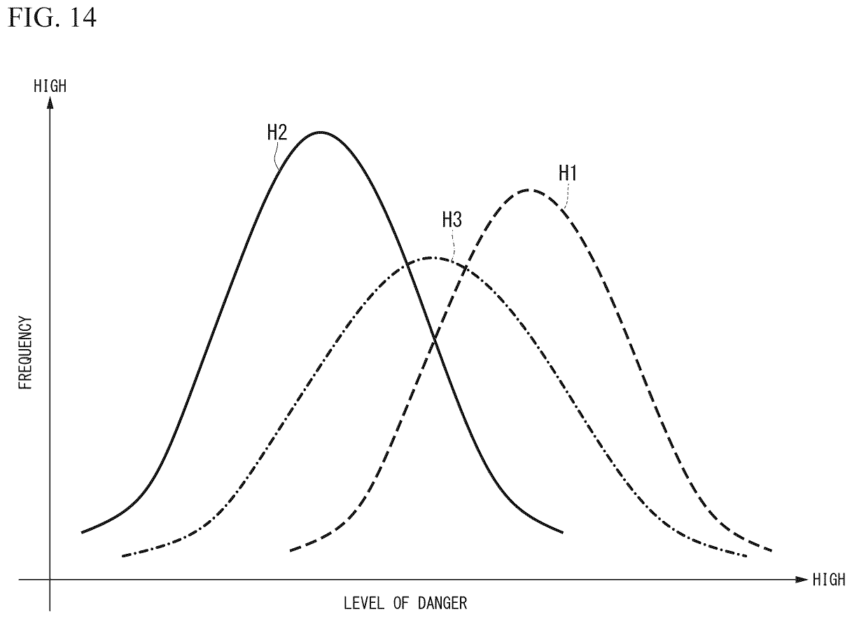

The first terminal device T1 (the notifier 84) outputs a notification based on the second notification information. FIG. 14 is a diagram showing an example of the notification performed by the first terminal device T1 (the notifier 84). In the graph shown in FIG. 14, a vertical axis indicates frequency and a horizontal axis indicates a level of danger of driving. The graph includes first driving evaluation information H1, second driving evaluation information H2, and third driving evaluation information H3. The first driving evaluation information H1, the second driving evaluation information H2, and the third driving evaluation information H3 are ones showing averages of a plurality of pieces of first driving evaluation information, a plurality of pieces of second driving evaluation information, and a plurality of pieces of third driving evaluation information included in the driving ability information 72, respectively. The first terminal device T1 (the notifier 84) displays, as an image, a comparison result of the first driving evaluation information H1, the second driving evaluation information H2, and the third driving evaluation information H3.

According to the second embodiment described above, it is possible to detect the decline in the cognitive ability of the driver. By displaying, as an image, the comparison result described above on the first terminal device T1, the driver can objectively ascertain his or her own driving ability. When a third party (an instructor) in a driving school or the like attempts to improve the driving ability of the driver, the instructor numerically ascertains the driving ability of the driver, thereby contributing to establishing an appropriate instruction policy.

### Third Embodiment

Next, a third embodiment will be described, but a basic configuration is the same as that of the first embodiment. Therefore, the same configurations are denoted by the same reference numerals, description thereof is omitted, and only differences will be described.

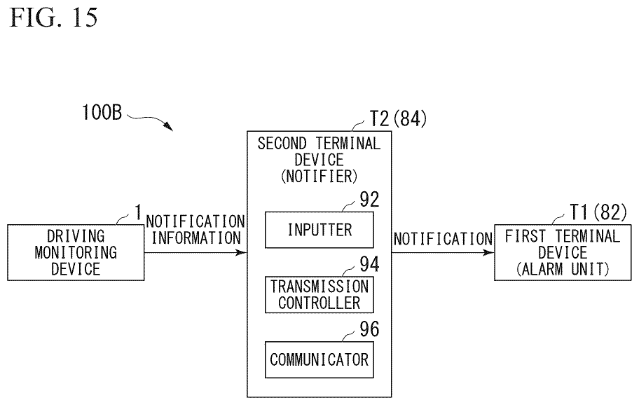

FIG. 15 is a diagram showing abnormality notification processing in an information processing system 100B according to the third embodiment. As shown in FIG. 15, the information processing system 100B according to the third embodiment includes a second terminal device T2, in addition to the driving monitoring device 1 and the first terminal device T1.

The second terminal device T2 is an information processing device used by a user (for example, an employee of a hospital or an insurance company) different from a driver who uses the first terminal device T1. The second terminal device T2 may be, for example, a smartphone, a tablet terminal, or a personal computer.

In the third embodiment, the driving monitoring device 1 (the notification controller 54) transmits the first notification information to the second terminal device T2 instead of the first terminal device T1. That is, in the third embodiment, the notifier 84 in which a notification is controlled by the notification controller 54 is the second terminal device T2 instead of the first terminal device T1. In the second terminal device T2, for example, an application for receiving a notification from the information processing device 2 is executed. The application causes an image, a character string, and the like based on information (such as the first notification information) transmitted by the information processing device 2 to be displayed on the display device, or causes sound to be emitted from the speaker.

The second terminal device T2 causes the first terminal device T1 to perform a notification based on information input by an operation of the user. The second terminal device T2 includes, for example, an inputter 92, a transmission controller 94, and a communicator 96.

The inputter 92 and the transmission controller 94 each include, for example, a hardware processor such as a CPU and a storage device that stores a program (software) (a storage device including a non-transitory storage medium), and functions of the respective components are realized by the processor executing the program. Some or all of these components may be realized by hardware (including circuitry) such as an LSI, an ASIC, an FPGA, and a GPU, or the functions of the components may be realized by cooperation between software and hardware. The functions of some or all of the components may be realized by a dedicated LSI. The communicator 96 is an interface for performing wireless communication or wired communication with an information processing device such as the first terminal device T1.

The inputter 92 receives a user operation and inputs the user operation to the second terminal device T2. The inputter 92 is configured using existing input devices such as a keyboard, a pointing device (a mouse, a tablet, or the like), a button, and a touch panel. The inputter 92 may be an interface for connecting an input device to the second terminal device T2. In this case, the inputter 92 inputs an input signal generated in accordance with the user operation in the input device to the second terminal device T2. The inputter 92 may be configured in any manner as long as the inputter 92 can input an instruction based on the user operation to the second terminal device T2.

For example, the user checks the content of the notification from the driving monitoring device 1 (the notification controller 54) to the second terminal device T2 and considers the content to be notified to the driver. The content to be notified to the driver is, for example, a possibility of a decline in cognitive ability, and a recommendation of a medical consultation at a medical institution for the purpose of discovering a decline in cognitive ability. The user inputs information including the considered notification content to the second terminal device T2 by operating the inputter 92. The transmission controller 94 transmits the information input by a user operation to the first terminal device T1 via the communicator 96. The first terminal device T1 performs a notification to the driver based on the transmitted information.

The information processing system 100B may be configured so that the driver can regulate the transmission of the first notification information from the driving monitoring device 1 (the notification controller 54) to the second terminal device T2 by operating the first terminal device T1 or the driving monitoring device 1. For example, when the driver operates the first terminal device T1 or the driving monitoring device 1, regulation information indicating presence or absence of the above transmission regulation of the first notification information may be generated, and the generated regulation information may be stored in the storage 70. The alarm controller 52 may determine whether or not to transmit the first notification information to the second terminal device T2 based on the regulation information stored in the storage 70. According to such a configuration, whether or not to inform a user who uses the second terminal device T2 of information relating to an abnormality of the driver is determined in accordance with an intention of the driver. Therefore, it becomes easier to protect privacy of the driver.

According to the third embodiment described above, the information processing system 100B includes the information processing device 2, the first terminal device T1 which is used by the driver and is not the notifier 84 in which a notification is controlled by the notification controller 54, and the second terminal device T2 which is used by a user different from the driver and is the notifier 84 in which a notification is controlled by the notification controller 54, and the second terminal device T2 causes the first terminal device T1 to perform a notification based on the information input by the operation of the user. Accordingly, notification content considered by the user who uses the second terminal device T2 can be provided to the driver who uses the first terminal device T1. For example, when a healthcare worker uses the second terminal device T2, it is possible to detect an abnormality of the driver using the abnormality determination information for a medical determination.

### Modification Examples

A technical scope of the present invention is not limited to the embodiments, and various changes can be added without departing from the gist of the present invention.

Information relating to a result of determination of overlooking in the overlooking determiner 41, for example, is accumulated in the storage 70, and content for a driver to review on his or her past driving (hereinafter referred to as “review content”), which is generated based on the accumulated information, may be provided to the driver by the first terminal device T1 (the alarm unit 82). The review content may include information (a character string, an image, or the like) from which the driver can check a risk object overlooked by the driver, for example. The review content may be generated by the driving monitoring device 1 (the information processing device 2) or may be generated by the first terminal device T1 (the alarm unit 82).

In the information processing system 100B according to the third embodiment, the driving monitoring device 1 (the notification controller 54) may transmit the first notification information to both the first terminal device T1 and the second terminal device T2. In other words, both the first terminal device T1 and the second terminal device T2 may be the notifier 84 in which a notification is controlled by the notification controller 54.

In the first embodiment, the driving monitoring device 1 (the information processing device 2) and the first terminal device T1 are configured as different devices, but the driving monitoring device 1 and the first terminal device T1 may be configured as an integrated device. For example, all of functions of the imager 10, the acquirer 20, the detector 30, the processor 40, the controller 50, the storage 70, the alarm unit 82, and the notifier 84 may be implemented in the driving monitoring device 1. Alternatively, all of these functions may be implemented in the first terminal device T1 or the vehicle M. Similarly, in the second embodiment, all of the functions of the imager 10, the acquirer 20, the detector 30, the processor 40, the controller 50, the storage 70, and the alarm unit 82 may be implemented in the driving monitoring device 1, and all of these functions may be implemented in the first terminal device T1.

The driving monitoring device 1 may be implemented using a plurality of information processing devices. For example, functions provided by the information processing device 2 may be implemented in the first terminal device T1 or the vehicle M (for example, an ECU). Alternatively, the driving monitoring device 1 may be implemented using a device such as a cloud. For example, in the driving monitoring device 1, the detector 30, the processor 40, the controller 50, and the storage 70 may be implemented in different information processing devices. For example, the storage 70 may be implemented in a distributed manner in a plurality of information processing devices.

The embodiments and modification examples described above can be expressed as follows.

An information processing device including
a storage medium that stores computer-readable instructions, and
a processor connected to the storage medium,
wherein the processor execute the computer-readable instructions to:
acquire a facial image including a face of an occupant of a vehicle,
determine whether or not there is a fellow passenger of the vehicle based on the facial image,
derive driving evaluation information relating to the driving ability of the driver of the vehicle,
determine whether or not an abnormality occurs in the driver based on a result of a comparison between the derived driving evaluation information and reference driving evaluation information when it is determined that there is the fellow passenger, and
cause a notifier to perform a notification when it is determined that the abnormality occurs in the driver.

The components in the embodiments described above can be appropriately replaced with well-known components without departing from the gist of the present invention, and the embodiments and modification examples described above may be appropriately combined.

What is claimed is:

1. An information processing device comprising:
a storage medium configured to store computer-readable instructions; and
one or more processors connected to the storage medium,
wherein the one or more processors execute the computer-readable instructions to:
acquire a facial image including a face of an occupant of a vehicle;
determine whether or not there is a fellow passenger of the vehicle based on the facial image;
derive driving evaluation information relating to the driving ability of the driver of the vehicle;
determine whether or not an abnormality has occurred in the driver based on a result of a comparison between the derived driving evaluation information and reference driving evaluation information
when it is determined that there is the fellow passenger; and
cause a notifier to perform a notification
when it is determined that the abnormality occurs in the driver.

2. The information processing device according to claim 1,
wherein the driving evaluation information is information indicating a level of danger of driving, and
the one or more processors execute the computer-readable instructions to
determine that the abnormality occurs in the driver
when it is determined that there is the fellow passenger and the derived driving evaluation information indicates that the level of danger is higher than the reference driving evaluation information.

3. The information processing device according to claim 1,
wherein the driving evaluation information is information indicating a level of danger of driving, and
the one or more processors execute the computer-readable instructions to
determine that an abnormality has not occurred in the driver
when it is determined that there is no fellow passenger and the derived driving evaluation information indicates that the level of danger is higher than the reference driving evaluation information.

4. The information processing device according to claim 1, wherein
the reference driving evaluation information is information derived based on one driving serving as a reference.

5. The information processing device according to claim 1, wherein
the reference driving evaluation information is information set based on the driving of the driver.

6. The information processing device according to claim 1, wherein
the reference driving evaluation information is information derived based on driving
when it is determined that there is no fellow passenger.

7. The information processing device according to claim 1, wherein
the reference driving evaluation information is information derived based on driving
when it is determined that there is the fellow passenger.

8. The information processing device according to claim 1, wherein
the reference driving evaluation information is information derived based on a predetermined number of driving operations.

9. The information processing device according to claim 1, wherein the one or more processors execute the computer-readable instructions to:
acquire audio information in a cabin;
determine whether or not the driver is receiving a driving instruction based on the audio information and the facial image, the driving instruction being an instruction relating to a driving operation of the vehicle from the fellow passenger,
when the fellow passenger is present; and
perform no determination as to whether or not an abnormality occurs in the driver when it is determined that the driving instruction is received.

10. The information processing device according to claim 9, wherein the one or more processors execute the computer-readable instructions to:
cause a storage unit to store first driving evaluation information, second driving evaluation information and third driving evaluation information,
the first driving evaluation information being the driving evaluation information when there is no fellow passenger,
the second driving evaluation information being the driving evaluation information when the driving instruction is being received, and
the third driving evaluation information being the driving evaluation information when the driving instruction is not being received.

11. The information processing device according to claim 10, wherein the one or more processors execute the computer-readable instructions to:
compare the first driving evaluation information, the second driving evaluation information, and the third driving evaluation information; and
cause the notifier to output information relating to a result of the comparison.

12. The information processing device according to claim 1, wherein the one or more processors execute the computer-readable instructions to:
acquire a surrounding image of the vehicle;
detect a risk object in the surrounding image;
determine whether or not the driver has overlooked the risk object based on information relating to a position of the risk object and information relating to the facial image; and
derive the driving evaluation information based on a result of determining whether or not the driver overlooks the risk object.

13. The information processing device according to claim 1, wherein the one or more processors execute the computer-readable instructions to:
derive the driving evaluation information based on some or all of information relating to a speed of the vehicle and information relating to a traveling direction of the vehicle.

14. An information processing system comprising:
the information processing device according to claim 1;
a first terminal device used by the driver, the first terminal device being not the notifier in which the notification is controlled; and
a second terminal device used by a user different from the driver, the second terminal device being the notifier in which the notification is controlled,
wherein the second terminal device causes the first terminal device to perform a notification based on information input by an operation of the user.

15. An information processing method comprising:
acquiring, by a computer, a facial image including a face of an occupant of a vehicle;
determining, by the computer, whether or not there is a fellow passenger of the vehicle based on the facial image;
deriving, by the computer, driving evaluation information relating to the driving ability of the driver of the vehicle;
determining, by the computer, whether or not an abnormality occurs in the driver based on a result of a comparison between the derived driving evaluation information and reference driving evaluation information when it is determined that there is the fellow passenger; and
causing, by the computer, a notifier to perform a notification when it is determined that the abnormality occurs in the driver.

16. A non-transitory storage medium having a program stored therein, the program causing a computer to:
acquire a facial image including a face of an occupant of a vehicle;
determine whether or not there is a fellow passenger of the vehicle based on the facial image;
derive driving evaluation information relating to the driving ability of the driver of the vehicle;
determine whether or not an abnormality occurs in the driver based on a result of a comparison between the derived driving evaluation information and reference driving evaluation information when it is determined that there is the fellow passenger; and
cause a notifier to perform a notification when it is determined that the abnormality occurs in the driver.
